(19) United States
(12) Patent Application Publication
(10) Pub. No.: US 2011/0022460 A1
(43) Pub. Date: Jan. 27, 2011

(54) EXPLICIT ONLINE ADVERTISING EXPOSURE TERMS

(75) Inventors: Tarun Bhatia, Burbank, CA (US); Darshan V. Kantak, Pasadena, CA (US)

Correspondence Address: Mauriel Kapouytian & Treffert LLP, 151 1st Avenue, #23, New York, NY, 10003, US

(73) Assignee: Yahoo! Inc., Sunnyvale, CA (US)

(21) Appl. No.: 12/507,330

(22) Filed: Jul. 22, 2009

(51) Int. Cl. G06Q 30/00

(52) U.S. Cl. 705/14.46; 705/14.5; 705/14.52; 705/14.68

(57) ABSTRACT

Methods and systems are provided for managing online advertising. Advertisers can specify requirements or preferences relating to advertisement exposures. The requirements or preferences can include, during a period of time, a minimum number of users exposed to an advertisement or group of advertisements, a range of exposures per exposed user, an average number of exposures per exposed users and an allowed variation about the average. Advertisement serving planning and advertisement serving are facilitated based in part on the specified requirements or preferences.

### BACKGROUND

In the online advertising marketplace, advertisers can enter into agreements to pay to have their advertisements served. The agreements can include various requirements and preferences, such as, for example, targeting aspects, display aspects, network or publisher aspects, and other aspects. The agreement may also include pricing provisions, provisions relating to consequences if terms of the agreement are not met, and many other provisions.

Advertisers naturally desire as much control as possible over factors such as the reach and frequency of exposure to users of specific advertisements or groups of advertisements. For example, such factors can greatly affect advertiser planning and optimizing return-on-investment for advertising spending. Recent advances in technology have occurred that allow much better and more granular targeting, serving, and tracking of advertisements. In spite of such advances, however, advertiser controls, in terms of ability to specify requirements and preferences, as well as the ability to accommodate those, have not grown nearly as much. For example, currently available contract types include providing a guaranteed number of impressions or a guaranteed frequency cap. These and other available types of contracts, however, do not provide advertisers with a sufficiently high degree of specificity and control regarding reach and user exposure aspects of their advertising campaign and specific advertisements.

There is a need for methods and systems for allowing advertisers to specify requirements and preferences in agreements or arrangements relating to serving of online advertisements, and for methods and systems to accommodate such specified requirements and preferences.

### SUMMARY

Recent advances in technology allow better and more granular targeting, serving and tracking of online advertisements, even down to the level of individual users. Some embodiments of the present invention allow advertisers to specify requirements or preferences, in relation to advertising agreements, that make use of such advances, and to accommodate, partially accommodate, or make efforts to accommodate the requirements or preferences. In some embodiments, advertisers can specify one, or a combination of several or all, of the requirements or preferences.

Some embodiments of the invention provide methods and systems for managing online advertising. Advertisers can specify requirements, preferences, or other terms relating to advertisement exposures. The terms can include, among other things, a minimum number of users exposed to an advertisement or group of advertisements, a range of exposures per exposed user, and an average number of exposures per exposed user and an allowed variation about the average. Advertisement serving planning and advertisement serving are facilitated or accomplished based in part on the specified terms. In some embodiments, terms must be deemed feasible before being accepted. An interface may be provided to advertisers to allow communications regarding terms.

Some embodiments of the invention provide systems, methods, or computer readable media containing instructions for executing a method to allow advertisers to provide reach and exposure requirements relating to an advertisement, group of advertisements, or advertising campaign. Herein, the term “advertiser” can broadly include any person, persons, or entity that provides, facilitates providing, or helps or partially provides, advertisement exposure related requirements or preferences as described herein in connection with a proposed agreement or actual agreement.

Some embodiments provide a method including, using one or more computers, providing one or more interfaces allowing, in relation to an advertising agreement or a proposed advertising agreement, specification of any of a set of advertisement exposure requirements. The set of requirements relate to serving of a set of one or more advertisements during a specified period of time to a set of users. The set of requirements include a minimum number of users served, a minimum number of exposures per served user, a maximum number of exposures per served user, and an average amount of exposures per served user. The method further including obtaining and storing a first set of information specifying one or more of the set of requirements. The method further includes allocating advertisement serving opportunities to allow satisfaction of the specified one or more requirements. The method further includes facilitating serving of advertisements to satisfy the specified one or more requirements.

In some embodiments, the requirements that advertisers may specify include allowing specification of a minimum proportion of users, such as a percentage, among a particular group, to be exposed to an advertisement of the set of one or more advertisements during the specified period of time. Furthermore, in some embodiments, the requirements that advertisers may specify include a specific set of one or more exposures, for example, the first exposures to occur to a given user after a specified time or a specified event.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a flow diagram of a method according to one embodiment of the invention;

FIG. 4 is a conceptual block diagram of elements of an advertising management program according to one embodiment of the invention; and

FIG. 5 is a flow diagram according to one embodiment of the invention.

While the invention is described with reference to the above drawings, the drawings are intended to be illustrative, and the invention contemplates other embodiments within the spirit of the invention.

### DETAILED DESCRIPTION

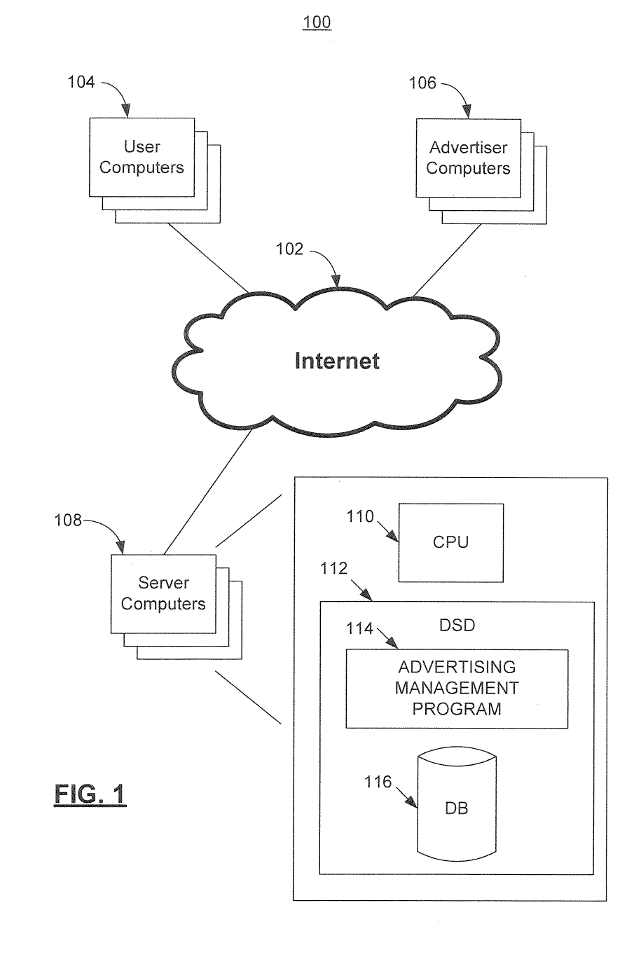

FIG. 1 is a distributed computer system 100 according to one embodiment of the invention. The system 100 includes user computers 104, advertiser computers 106 and server computers 108 connected or connectable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context. As depicted, each of the server computers 108 includes one or more CPUs 110 and a data storage device 112.

The data storage device 112 includes one or more databases 118, as well an advertising management program 114.

The advertising management program 114 is intended to broadly include all programming, algorithms, applications, software, graphical user interfaces, models, and other and tools or procedures necessary to implement or facilitate methods and systems according to embodiments of the invention, or computerized aspects thereof. The program 114 may exist on one computer or may be distributed among multiple computers or devices.

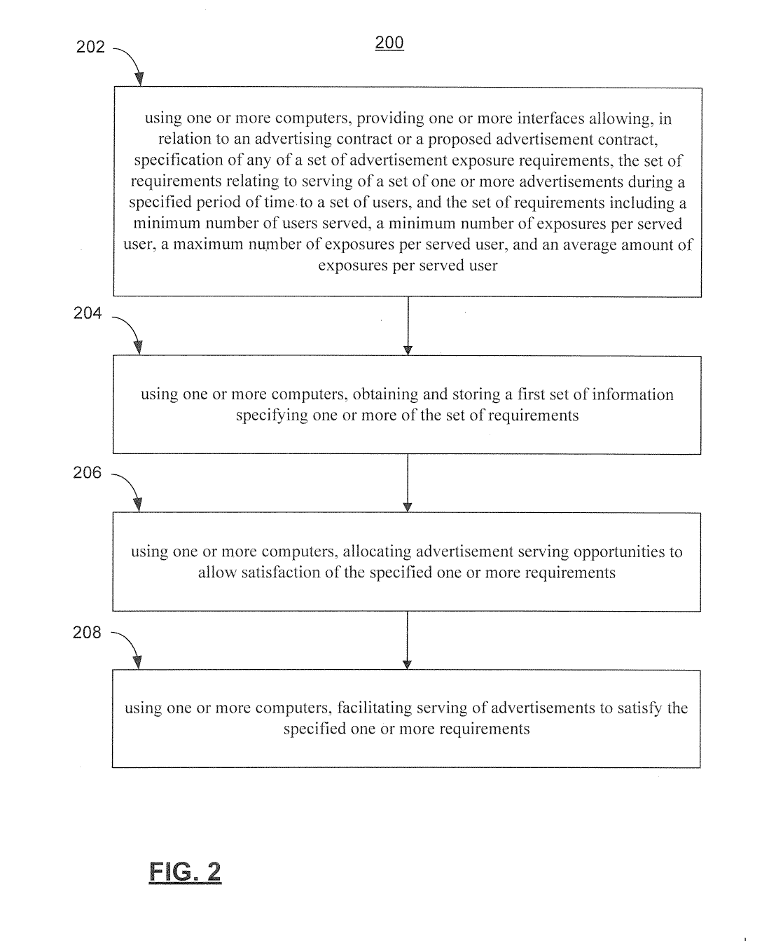

FIG. 2 is a flow diagram of a method 200 according to one embodiment of the invention. The method 200 may be implemented or facilitated using the advertising management program. At step 202, using one or more computers, one or more interfaces are provided allowing, in relation to an advertising agreement or a proposed advertisement agreement, specification of any of a set of advertisement exposure requirements. The set of advertisement exposure requirements relate to serving of a set of one or more advertisements during a specified period of time to a set of users. The set of requirements include a minimum number of users served, a minimum number of exposures per served user, a maximum number of exposures per served user, and an average amount of exposures per served user. As used herein, the term “agreement” broadly refers to any of various types of arrangements relating to online advertising.

At step 204, using one or more computers, a first set of information specifying one or more of the set of requirements is obtained and stored.

At step 206, using one or more computers, advertisement serving opportunities are allocated to allow satisfaction of the specified one or more requirements.

Finally, at step 208, using one or more computers, serving of advertisements to satisfy the specified one or more requirements is facilitated.

In some embodiments, advertisers may specify a minimum number of users exposed to a particular set of one or more advertisements over a specified period of time. Furthermore, herein, an exposure occurs when an advertisement is served to a user. Still further, herein, a user is exposed to an advertisement when an advertisement is served to the user.

In some embodiments, the method 200 includes, with respect to various requirements in connection with reach and exposures as described herein, using or expending as many impressions as necessary to satisfy the term.

In some embodiments, in addition to specifying requirements, advertisers can express preferences, desires, or other terms, such as required or preferred targeting criteria.

In some embodiments, advertisers may specify a required minimum as well as a maximum number of exposures to a particular set of one or more advertisements over a specified period of time, per user that is exposed at least once to an advertisement of the set over the specified period of time. These factors can be important in optimizing the effect of advertisements. For example, above a certain level of exposure, an advertisement may no longer be as effective, and may even grow annoying. On the other hand, under certain circumstances, a certain minimum number of exposures may also be desirable.

In some embodiments, advertisers may specify a required average amount of exposures to a particular set of one or more advertisements over a specified period of time, per user that is exposed at least once to an advertisement of the set over the specified period of time. The amount can be expressed as a number of exposures, or as a number of exposures that falls within a specified numerical range. Furthermore, in embodiments, advertisers can specify a required maximum variation or deviation about the average.

In addition, in some embodiments, various other requirements or preferences may be specified, whether at the user level or at a higher level, such as the campaign level. For example, other terms regarding reach and frequency of exposures to individual users may be specified. Furthermore, other higher level or aggregate terms may be specified, such as exposure statistics that satisfy a certain function, distribution or curve for a campaign or portion of a campaign, etc. Still further, some embodiments include specifying terms relating not just to user exposures, but to further or other aspects of user involvement, engagement, or actions, such as click or selection, click through to a certain point, buying or other action, etc.

Various embodiments of the invention are used in connection with various types of contracts and agreements with advertisers, such as guaranteed contracts as well as non-guaranteed contracts. In some embodiments, specified requirements can be aspects of guaranteed contracts.

In some embodiments, relevance is improved by optimized serving in accordance with specified terms. In some embodiments, information specifying one or more of the set of advertising exposure requirements is obtained and stored, such as in a database. Serving opportunities may be allocated to allow satisfaction of the specified one or more requirements. Advertisements may be served, or advertisement serving may be facilitated, to satisfy the specified one or more requirements.

In some embodiments, targeting, such as behavioral targeting, geotargeting, etc., are incorporated. For example, advertisers may limit or express preferences regarding users to be exposed to advertisements, or groups of users, based on targeting criteria, etc.

Embodiments of the invention are used with all forms of online advertising, including advertising in connection with user keyword queries, including sponsored search advertising or listings, and advertising not so associated, such as banner advertising. All forms of advertising are contemplated, including video advertising, audio advertising, advertising on cell phones or other portable devices, etc. In some embodiments, targeting criteria can include search query related criteria.

In some embodiments, the requirements that advertisers may specify include allowing specification of a specific set of one or more exposures, the specific set of exposures being the first exposures to occur to a given user after a specified time or a specified event. For some examples, advertisers may specify the first exposures to a user of the day, week etc., the first five exposures after a user arrives at a particular type of site such as a financing site, the first ten exposures after a sporting event concludes, etc. More broadly, such terms may relate to exposures for users that are in a particular state, which may be evaluated based on various conditions. For example, such conditions may include pertaining to the activity of the user, the local time zone, the absolute time, other conditions, or a combination of conditions.

In some embodiments, advertisers are provided with options to set or request various types of requirements relating to reach and exposures, as described herein. Advertisers may choose to set one these, or several in combination. In some embodiments, in a sense, these options provide highly granular user controls with respect to reach and exposure, which can be used to optimize their advertising campaigns. The term “controls” is here used broadly to include expressions of requirements, preferences, and other obligatory or non-obligatory terms or aspects, such as terms relating to elements of an advertising campaign. Some embodiments provide a platform-independent solution for customers or advertisers, or for groups thereof, who may pool their resources or audiences together.

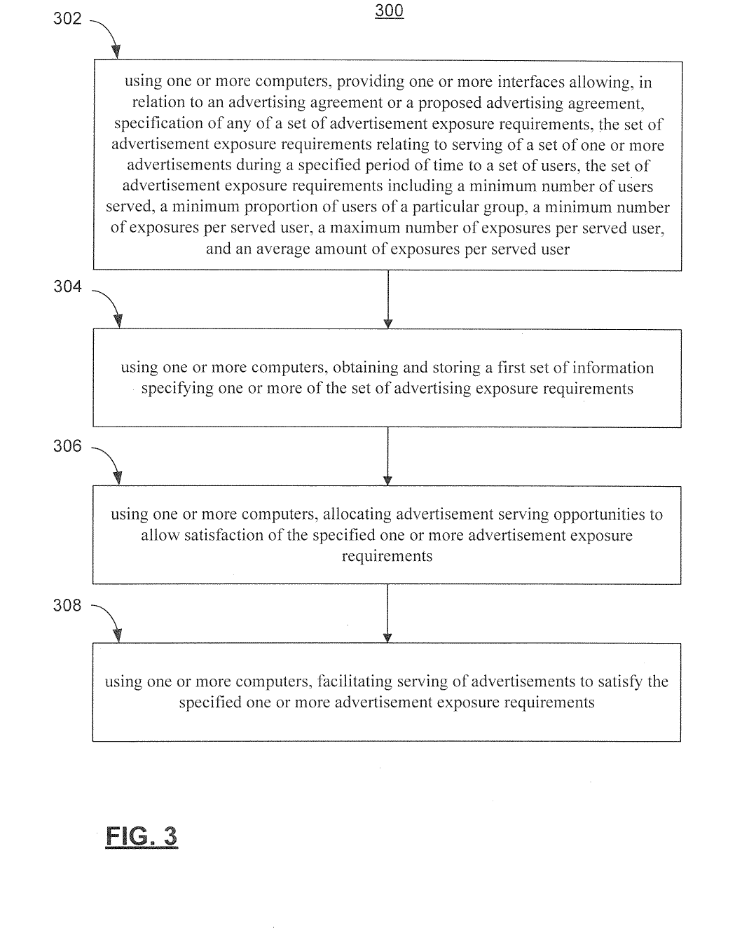

FIG. 3 is flow diagram of a method 300 according to one embodiment of the invention. The method 300 may be implemented or facilitated by an advertisement management program.

Step 302 is similar to step 202 as depicted in FIG. 2, except that the set of advertisement exposure requirements that advertisers may specify include allowing specification of a minimum proportion of users, among a particular group, to be exposed to an advertisement of the set of one or more advertisements during the specified period of time. For example, this may include allowing advertisers to specify a minimum percentage of a certain group of targeted users to be so exposed.

Steps 304, 306 and 308 of FIG. 3 are similar to steps 204, 206 and 208 as depicted in FIG. 2.

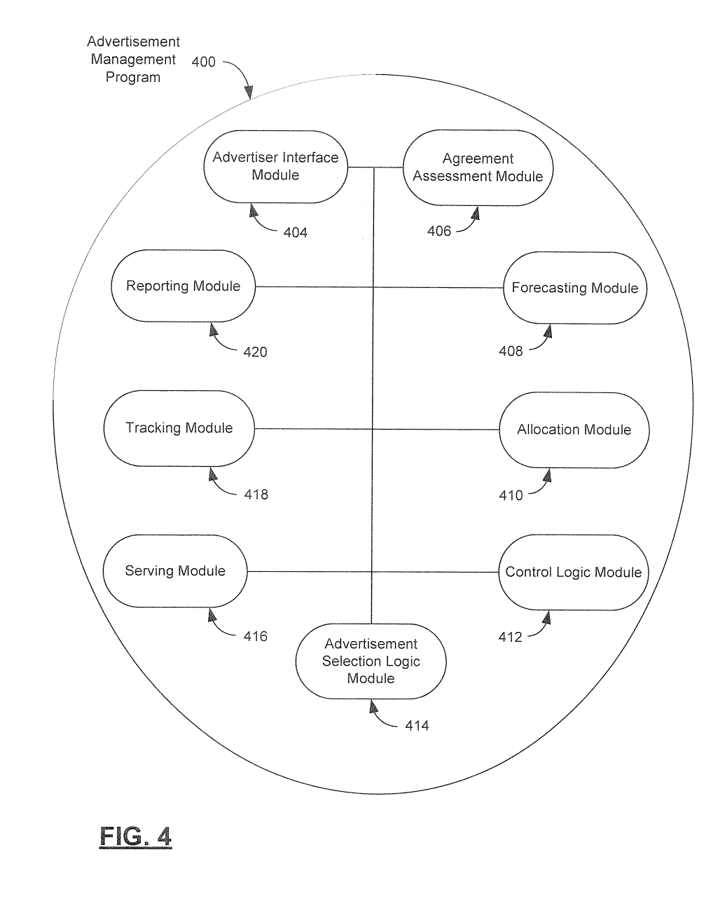

FIG. 4 is a conceptual block diagram of elements included in an advertisement management program 400 according to one embodiment of the invention.

As depicted, advertisement management program 400 includes a number of modules. Specifically, the program includes an advertiser interface module 404, an agreement assessment module 406, a forecasting module 408, an allocation module 410, a control logic module 412, an advertisement selection logic module 414, a serving module 416, a tracking module 418, and reporting module 420.

The modules 404-420 are broadly intended to represent any of various aspects of an advertisement management program, primarily by function, such as software and programming, whether on one computer or distributed among several computers. It is to be understood that, while depicted separately for simplicity, the functions of the models may overlap and not be fully distinct, and the software or other aspects embodying them may also not be separate. Furthermore, it is to be understood that an advertisement management program may include other modules or aspects not included in FIG. 4.

In some embodiments, all of the modules 404-420 may communicate with each other and databases and other resources or entities, as appropriate.

The advertiser interface module 404 includes functionality relating to interfacing and communicating with advertisers. For example, the module 404 can include graphical user interfaces allowing two-way communications with advertisers.

The agreement assessment module 406 includes functionality relating to assessing proposed terms provided by an advertiser, as may be entered as facilitated by the advertiser interface module 404. The module may access information in a database to make the assessment, such as, for example, information relating to forecasting advertising opportunities, other agreements, etc. and providing feedback if appropriate. The module 406 may also facilitate communications with an advertiser regarding terms. For example, if an advertiser proposes terms, such as requirements, that are determined not to be feasible, the module 406 may inform the advertiser of this, and may also provide other information such as potential feasible modified terms. As a further example, the module 406 may provide advertisers with availability counts, pricing information, etc.

The agreement assessment module 406 also includes functionality to determine if specified requirements, and agreements, are feasible, and to permit formation of the agreement or contract, or booking, only if feasibility is determined to exist. In some embodiments, the module 406 may make determinations based in part on a determined risk or cost associated with particular terms.

The forecasting module 408 includes functionality relating to forecasting and prediction in connection with advertisement serving and advertisement serving opportunities. Forecasting information can be used in planning of advertisement serving.

In some embodiments, the forecasting module 406 uses information such as historical data on advertisement serving opportunities, information regarding additional properties in terms of unique users, and predicts an anticipated number of targeted unique users in a given period, and their level of exposure within that period. Specific exposures, such as first in a day or weekday, etc. may also be forecasted. In some embodiments, the forecasting takes into account selectively reaching only such users that are likely to satisfy the exposure requirements or preferences per user and for the entire population with a desired or appropriate level of certainty. Furthermore, the forecasting module 406 updates and corrects based on new information and developments as appropriate.

The allocation module 410 includes functionality relating to near-term planning of advertisement serving, including allocation of advertisement inventory to advertisement serving opportunities.

In some embodiments, the allocation module includes functionality including centrally managing all booked and anticipated contracts or agreements, both impression-based and unique user and exposure based, and allocating a forecasted supply of impressions, users, and their exposures to satisfy campaign goals. This allocation component can, among other things, inform the advertiser interface module 404.

In some embodiments, event information is flagged to allow for discerning the eligibility of campaigns for specific users and the individual exposures that must be targeted. These events correspond to the specific type of terms involved. Counters specific to unique users and the number of times they have been touched by a campaign creative within relevant periods are maintained in real time to inform advertisement serving.

The control logic module 412 includes functionality relating to informing planning of advertisement serving considering multiple advertising agreements, time periods, states of partial fulfillment, etc. The module 412 is used, for example, to help ensure that advertisement serving, including matching, is optimized with regard to agreement or contract fulfillment.

In some embodiments, the module 412 ensures or facilitates that requirements are fulfilled, such as overall campaign exposure and exposure curve and distribution properties, by controlling specific unique users that are shown ads, the number of exposures within a period for each such user, or in other ways. In various embodiments, different means and standards may be used in determining with a sufficient degree of confidence that terms are satisfied, and that a sufficient degree of accuracy is achieved.

The advertisement selection logic module 414 includes functionality relating to selecting advertisements to serve in connection with actual advertisement serving opportunities.

The serving module 416 includes functionality relating to facilitating serving of advertisements in connection with advertisement opportunities, and, in some embodiments, includes serving advertisements.

The tracking module 418 includes functionality relating to tracking and storing information or statistics relating to advertisement serving. The tracking module can be used to track information used to determine fulfillment of agreement terms. This can include tracking number of users exposed to a specific advertisement or group of advertisements, tracking a number of exposures per user, etc.

In some embodiments, statistics are maintained in accordance with advertisement serving from periodically generated event logs generated. The statistics may be periodically aggregated and communicated to modules, such as the control logic module 412, to inform of progress toward a requirement or goal.

The reporting module 420 includes functionality relating to generating and making available or providing reporting to advertisers or other users, relating to, for example, fulfillment of agreements or contracts, and associated statistics. The reporting module 420 uses, among other information, information obtained by the tracking module.

In some embodiments, functionality of various aspects of an advertisement management program include, with respect to exposures or impressions or advertisement serving opportunities, detecting, tracking, counting, forecasting, matching, and allocating. These and other functionalities may be in addition or combination with prior art capabilities, including impression-based contract capabilities.

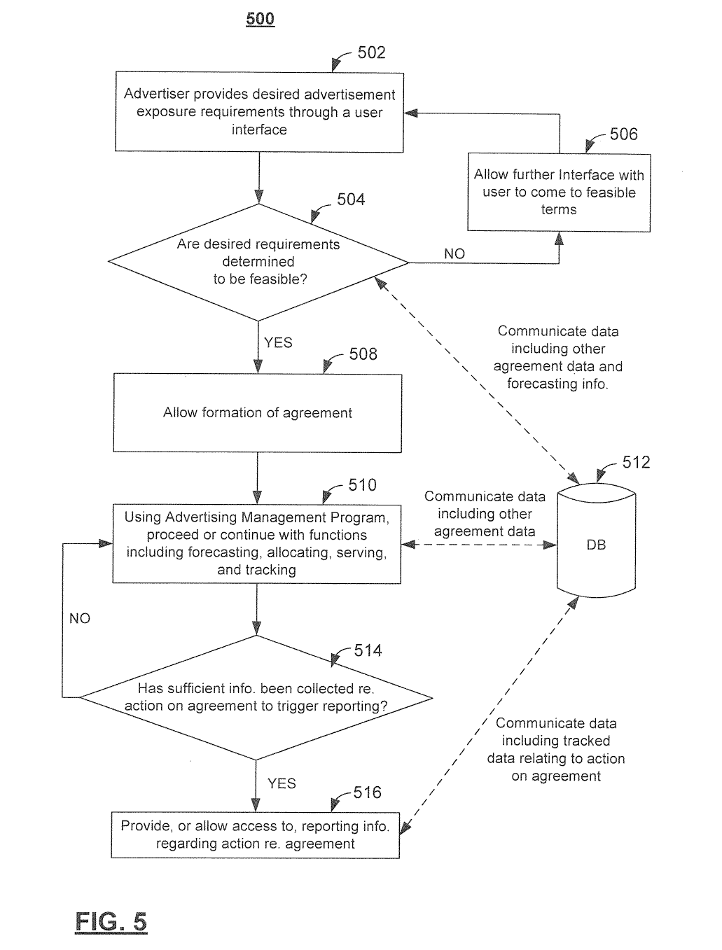

FIG. 5 is a flow diagram of a method 500 according to one embodiment of the invention. The method 500 may be implemented or facilitated by an advertisement management program.

At step 502, an advertiser provides desired advertisement exposure requirements through a user interface.

At step 504, the method 500 queries whether desired requirements are determined to be feasible. If “no”, then the method returns to step 506, where additional interface with the advertiser and changing of specified requirements is enabled. If “yes” then the method 500 proceeds to step 508. Step 504 may also include communication of information with the database 512. For example, information required to determine feasibility may be accessed from the database 512, which may include, for example, forecasting information and information regarding other agreements. Furthermore, the feasibility determination may be communicated to and stored in the database 512.

Although connections are not shown from the database 512 to all steps of the method 500, it is contemplated that information may be communicated with the database in association with any of the steps.

At step 508, an agreement is allowed to be formed including specified advertisement exposure requirements.

At step 510, using an advertising management program, the method 500 proceeds or continue with functions including forecasting, allocating, serving, and tracking, among other functions.

At step 514, the method 500 queries whether sufficient information has been collected regarding action on the agreement to lead to reporting. Sufficient information may be collected, for example, when advertisement serving has been accomplished sufficiently to satisfy the specified requirements. If “no”, then the method 500 continues at step 510. If “yes”, then the method 500 proceeds to step 516.

Finally, at step 516, reporting is provided or made accessible regarding action taken regarding the agreement. For example, advertisement serving has been determined to be sufficient to have satisfied requirements of an agreement, reporting may be provided informing an advertiser of such. The reporting may further provide related summary and specific statistical information.

The foregoing description is intended merely to be illustrative, and other embodiments are contemplated within the spirit of the invention.

What is claimed is:

1. A method comprising:
using one or more computers, providing one or more interfaces allowing, in relation to an advertising agreement or a proposed advertising agreement, specification of any of a set of advertisement exposure related requirements, the set of requirements relating to serving of a set of one or more advertisements during a specified period of time to a set of users, the set of requirements comprising:
a minimum number of users to be exposed to an advertisement of the set of one or more advertisements during the specified period of time;
a minimum number of exposures to an advertisement of the set of one or more advertisements during the period of time, per user that is exposed at least once to an advertisement of the set of one or more advertisements during the period of time;
a maximum number of exposures to an advertisement of the set of one or more advertisements during the period of time, per user that is exposed at least once to an advertisement of the set of one or more advertisements during the period of time; and
an average amount of exposures to an advertisement of the set of one or more advertisements during the period of time, per user that is exposed at least once to an advertisement of the set of one or more advertisements during the period of time, wherein the average amount is specified as an average number of exposures or as an average number of exposures that falls within a specified numerical range;
using one or more computers, obtaining and storing a first set of information specifying one or more of the set requirements;
using one or more computers, allocating advertisement serving opportunities to allow satisfaction of the specified one or more requirements; and
using one or more computers, facilitating serving of advertisements to satisfy the specified one or more requirements.

2. The method of claim 1, wherein providing one or more interfaces allowing specification of any of a set of advertisement exposure requirements further comprises allowing specification of a minimum proportion of users, among a particular group, to be exposed to an advertisement of the set of one or more advertisements during the specified period of time.

3. The method of claim 1, comprising serving of advertisements to satisfy the specified one or more advertisement exposure requirements.

4. The method of claim I, wherein providing one or more interfaces allowing specification of any of a set of advertisement exposure requirements comprises allowing specification of a specific set of one or more exposures, the specific set of exposures being the first exposures to a given user to occur after a specified time or a specified event.

5. The method of claim 1, wherein providing one or more interfaces allowing specification of any of a set of advertisement exposure requirements comprises allowing specification of:
an average amount of exposures to an advertisement of the set of one or more advertisements during the period of time, per user that is exposed at least once to an advertisement of the set of one or more advertisements during the period of time;
and a specified maximum variation about the average amount.

6. The method of claim I, comprising providing one or more interfaces allowing specification of any of a set of advertisement exposure requirements, the set of advertisement exposure requirements relating to serving of a set of one or more advertisements during a specified period of time to a set of users, wherein the set of users is a set of users that satisfies a set of one or more targeting criteria.

7. The method of claim 1, wherein allocating advertisement serving opportunities comprises forecasting with respect to anticipated advertisement serving opportunities.

8. The method of claim 1, comprising:
determining, based on the information specifying one or more of the set of advertising exposure requirements and based on forecasting, whether to allow formation of a agreement including the specified one or more of the set of advertisement exposure requirements; and
communicating to a user information regarding the determination.

9. The method of claim 1, comprising:
tracking, in relation to individual users, serving of advertisements to the individual users to satisfy the specified one or more advertisement exposure requirements;
storing information relating to the tracking; and
providing reporting to at least one user relating to the stored information relating to the tracking.

10. A system comprising:
one or more server computers connected to the Internet; and
one or more databases connected to the one or more servers;
wherein the one or more server computers are for:
providing one or more interfaces allowing, in relation to an advertising agreement or a proposed advertising agreement, specification of any of a set of advertisement exposure related requirements, the set of requirements relating to serving of a set of one or more advertisements during a specified period of time to a set of users, the set of requirements comprising:
a minimum number of users to be exposed to an advertisement of the set of one or more advertisements during the specified period of time;
a minimum number of exposures to an advertisement of the set of one or more advertisements during the period of time, per user that is exposed at least once to an advertisement of the set of one or more advertisements during the period of time;
a maximum number of exposures to an advertisement of the set of one or more advertisements during the period of time, per user that is exposed at least once to an advertisement of the set of one or more advertisements during the period of time; and
an average amount of exposures to an advertisement of the set of one or more advertisements during the period of time, per user that is exposed at least once to an advertisement of the set of one or more advertisements during the period of time, wherein the average amount is specified as an average number of exposures or as an average number of exposures that falls within a specified numerical range;
obtaining, and storing in the one or more databases, a first set of information specifying one or more of the set of requirements;
allocating advertisement serving opportunities to allow satisfaction of the specified one or more requirements; and
facilitating serving of advertisements to satisfy the specified one or more requirements.

11. The system of claim 11, wherein providing one or more interfaces allowing specification of any of a set of advertisement exposure requirements further comprises allowing specification of a minimum proportion of users, among a particular targeted group, to be exposed to an advertisement of the set of one or more advertisements during the specified period of time.

12. The system of claim 10, wherein the one or more server computers are further for tracking, in relation to individual users, serving of advertisements to the individual users to satisfy the specified one or more advertisement exposure requirements.

13. The system of claim 12, wherein the one or more server computers are further for generating information relating to the tracking and storing the information relating to the tracking in the one or more databases.

14. The system of claim 13, wherein the information relating to the tracking comprises information relating to the amount of times that each of a set of users receives an advertisement to satisfy the specified one or more advertisement exposure requirements.

15. The system of claim 10, wherein the one or more servers are further for serving of advertisements to satisfy the specified one or more advertisement exposure requirements.

16. The method of claim 10, wherein providing one or more interfaces allowing specification of any of a set of advertisement exposure requirements comprises allowing specification of a specific set of one or more exposures, the specific set of exposures being the first exposures to occur to a given user after a specified time or a specified event.

17. The system of claim 10, wherein the set of users to whom advertisements may be served to fulfill the agreement is a set of users that satisfy a set of one or more targeting criteria.

18. The system of claim 10, wherein allocating advertisement serving opportunities comprises forecasting with respect to anticipated advertisement serving opportunities.

19. The system of claim 10, wherein the server computers are further for generating reporting information for at least one user relating to serving of advertisements that satisfy the specified one or more advertisement exposure requirements.

20. A computer readable medium or media containing instructions for executing a method, the method comprising:
using one or more computers, providing one or more interfaces allowing, in relation to an advertising agreement or a proposed advertising agreement, specification of any of a set of advertisement exposure requirements, the set of requirements relating to serving of a set of one or more advertisements during a specified period of time to a set of users, the set of requirements comprising:
a minimum number of users to be exposed to an advertisement of the set of one or more advertisements during the specified period of time;
a minimum proportion of users, among a particular group, to be served an advertisement of the set of one or more advertisements during the specified period of time;
a minimum number of exposures to an advertisement of the set of one or more advertisements during the period of time, per user that is exposed at least once to an advertisement of the set of one or more advertisements during the period of time;
a maximum number of exposures to an advertisement of the set of one or more advertisements during the period of time, per user that is exposed at least once to an advertisement of the set of one or more advertisements during the period of time; and
an average amount of exposures to an advertisement of the set of one or more advertisements during the period of time, per user that is exposed at least once to an advertisement of the set of one or more advertisements during the period of time, wherein the average amount is specified as an average number of exposures or as an average number of exposures that falls within a specified numerical range;
using one or more computers, obtaining and storing a first set of information specifying one or more of the set of requirements;
using one or more computers, allocating advertisement serving opportunities to allow satisfaction of the specified one or more requirements; and
using one or more computers, facilitating serving of advertisements to satisfy the specified one or more requirements.
